(19) United States
(12) Patent Application Publication
(10) Pub. No.: US 2002/0022453 A1
(43) Pub. Date: Feb. 21, 2002

(54) Dynamic protocol selection and routing of content to mobile devices

(76) Inventors: Horia Balog, Toronto (CA); Derrol Salmon, Toronto (CA); Peter J. DeVries, Toronto (CA); Mark Saks, Richmond Hill (CA); Bernie Jansen, Burlington (CA); Simon Arnison, Harwell (GB)

Correspondence Address: DORSEY & WHITNEY, LLP, SUITE 4700, 370 SEVENTEENTH STREET, DENVER, CO, 80202-5647, US

(21) Appl. No.: 09/823,654

(22) Filed: Mar. 30, 2001

Related U.S. Application Data
(60) Provisional application No. 60/193,816, filed on Mar. 31, 2000.

(51) Int. Cl. H04B 5/00

(52) U.S. Cl. 455/41; 455/414; 455/426

(57) ABSTRACT

A method for delivering content to a plurality of mobile devices communicatively coupled to each other via BLUETOOTH technology and participating in a communication network is provided. The content includes a plurality of data types and is delivered from a service provider to at least one of the mobile devices depending on the characteristics of the data and the characteristics of the device. The method includes the steps of associating a user with a global profile having the characteristics of the devices and user attributes, storing the global profile on the service provider; dynamically selecting an optimal communication protocol for transport of the content based on the data type and selecting at least one of the mobile devices being best suited to receive the data type. Thus, the content is routed to one of the devices in accordance with the global profile, data characteristics and prevailing network conditions.

### FIELD OF THE INVENTION

The present invention relates to the distribution of content in a mobile communication network, more particularly it relates to determining an optimal protocol and to selecting a device for successful content delivery.

### BACKGROUND OF THE INVENTION

The advent of various wireless networking and communications technologies, standards and protocols has enabled a new class of applications with different topologies and new features. The convergence of the data and voice networks, devices and applications is adding more complexity to the content, and to the end users of the technologies. For example, one service may support multiple types of content, such as, a video which includes the components of audio, video and text, while a broadcast service may support video and audio, whereas interactive broadcast service would support audio, video, and text messaging.

The provision of data, voice and voice/data services as value added services in wireless carrier and enterprise networks has opened a new area for computing applications. This area encompasses a complex and distributed wireless environment including computer systems, networks, telecommunication systems, static and mobile devices such as computers, personal digital assistants (PDAs) and Internet-enabled mobile phones. This trend has effectively extended traditional personal computer application services to mobile devices. Accordingly, the adoption of wireless technology by businesses and consumers has been phenomenal, in that it provides consumers with access to up-to-the-minute information such as stock alerts or news, enables mobile e-commerce and increases business and individual productivity. As has already been witnessed on the World Wide Web (WWW), personalization of services for the user is key for customer retention. Such services include news and information retrieval, instant messaging and chat, mobile commerce and online account management. Therefore such intimate interactions require the customer's permission, and personalizing thus dictates that the consumer retains control in this arrangement often termed “permission marketing”. The user can thus control the information “pushed” to them by setting the parameters for what is relevant to them and these parameters can be dynamic and can be time-dependent. This is the nature of pervasive computing, where users, including enterprise users, rely on the electronic creation, storage, and transmittal of personal, financial, and other confidential information, demand the highest security and quality of service for all of these transactions, and require access to time-sensitive data, regardless of their physical location.

Traditionally, wireless voice and data services and applications were built in dedicated, proprietary and closed communication systems and networks. With the introduction of technologies in the unlicensed wireless spectrum and the advances in electronics, personal mobile devices, networking equipment and standards, the flexibility and capabilities of the networks allow for more advanced services to be provided to the end user. The move to wireless communications has also been aided by a number of factors, such as, the availability of a range of unlicensed frequencies in the 2.4 to 2.4835 GHz band and 5-GHz band, a larger mobile work force and emerging wireless standards. Among these standards are the IEEE 802.11 standard for professional and wireless-LAN applications, BLUETOOTH® and HomeRF's Shared Wireless Access Protocol (SWAP).

The BLUETOOTH specification defines a universal radio interface in the 2.45 GHz frequency band that enables wireless electronic devices to connect and communicate wirelessly via short-range, ad hoc networks.

Given the wide adoption and acceptance of wireless communication and penetration of mobile devices in most populations, it is not unusual for a consumer to have a number of such devices. For example, a consumer may be presented with a choice of a mobile phone, a PDA or personal computer, and by implementing BLUETOOTH connectivity between these devices, these devices can form an ad hoc wireless network. In such a network, each device can operate not only as a host but also a router, forwarding data packets for other mobile devices in the network that may not be within communication range of each other. This flexibility gives rise to a large set of opportunities to build new application models and new mechanisms to enhance the mobile computing experience. The entire BLUETOOTH protocol stack includes radio, baseband, and software layers and provides for interoperability between devices from different manufacturers for specific services and usage models. The general usage models are defined by the BLUETOOTH Profiles Specification and these include generic, telephony, networking, serial, and object exchange. The profile defines a selection of messages and procedures, or capabilities, from the BLUETOOTH specifications and gives an unambiguous description of the interface for specified services and use cases.

One of the problems in delivering the multitude of services to the different device is the challenge of determining the different media types, application profiles and connection types. The combination of numerous BLUETOOTH stacks, devices, access points and the multiple layers of protocols and profiles provide a challenge to service developers, implementers and integrators who need to create end-to-end mobile solutions. This problem is further complicated by the fact that although standards exist for BLUETOOTH there are numerous incompatibilities in the actual implementations. This is especially true in the short term because of the immaturity of the BLUETOOTH market and standard. However, regardless of the evolution of the standards and the markets, there will continue to be incompatibilities stemming from the wide variety and market penetration of the BLUETOOTH enabled devices.

As mentioned above, the user will often have multiple, BLUETOOH enabled devices using a variety of protocols, operating environments and applications and in complex topologies. This presents yet another problem for the user, since the user has the onus to determine which of the available devices support the desired content. For example, suppose a user with a laptop computer and a cellular phone desires to receive streaming video, the user would require knowledge of the data type of the content, the video format, streaming method, and a suitable protocol in order to determine the protocol for acceptable presentation on one of the devices. Therefore, the user is required to have some level of knowledge and understanding of these technologies in order to access the content.

Accordingly, it is an object of the present invention to mitigate at least one of the above disadvantages.

### SUMMARY OF THE INVENTION

In one of its aspects the present invention provides a method for delivering content to a user, where the user has a plurality of mobile devices communicatively coupled to each other in a communication network. The content includes a plurality of data types and is delivered from a service provider to at least one of the mobile devices depending on the characteristics of the data and the characteristics of the device. The method includes the steps of associating a user with a global profile having the characteristics of the devices and user attributes; selecting one of the devices best suited for reception of the information in accordance with the global profile and the data type; and the service provider delivering the information to the selected device. Another aspect of the invention is the selection of an optimal communication protocol in the system in accordance with the predetermined global profile and the data type.

Typically, the user defines the global profile, although this may be performed by in part by the service provider. For enterprise users, the creation of the global profile may be performed by an administrator or a delegate, who may also determine of the type of content the enterprise user may subscribe to. The selection of the device for routing the content may also be determined based on the communication network operating conditions.

### BRIEF DESCRIPTION OF THE DRAWINGS

These and other features of the preferred embodiments of the invention will become more apparent in the following detailed description in which reference is made to the appended drawings wherein:

FIG. 1 shows a block diagram of an information distribution system in accordance with a preferred embodiment of the present invention;

FIG. 2 shows a global profile including user preferences and user device characteristics;

FIG. 3 shows a BLUETOOTH protocol stack, with both BLUETOOTH specific protocols and non-BLUETOOTH specific protocols;

FIG. 4 shows table illustrating an association of different media types with the corresponding application profiles and protocols;

FIG. 5 shows a flow diagram outlining the steps for delivering requested content to a user;

FIG. 6 shows a block diagram of an ad-hoc network with one of the devices acting as service provider, in a second embodiment; and

FIG. 7 shows a block diagram of an ad-hoc network with one user device routing content to other user devices, in a third embodiment.

### DESCRIPTION OF THE PREFERRED EMBODIMENTS

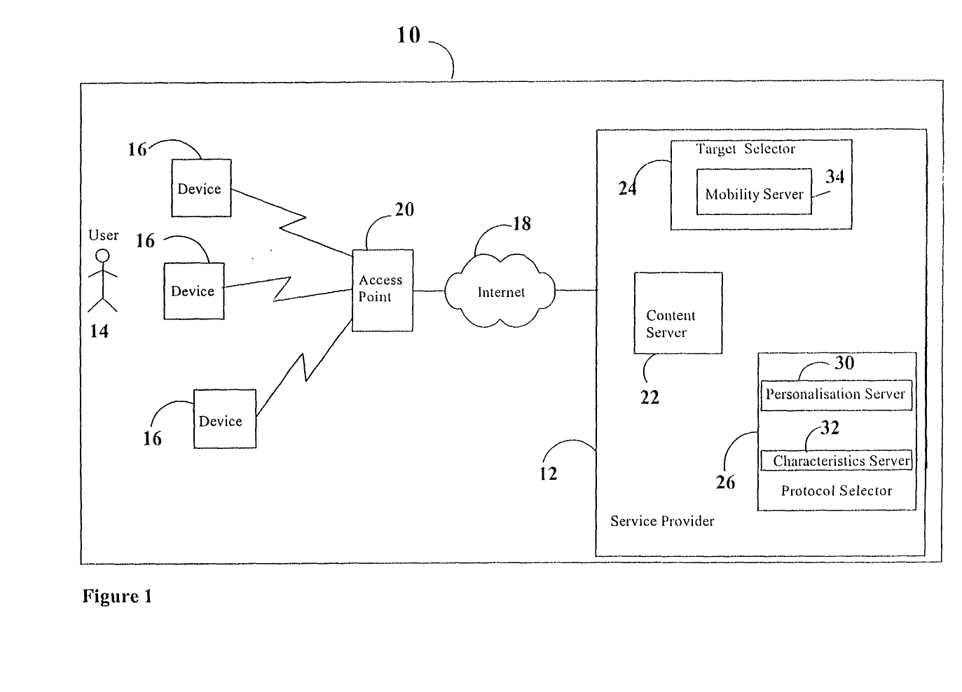

Reference is first made to FIG. 1, which shows the content distribution system generally, by numeral 10, according to a preferred embodiment. The system 10 comprises a service provider 12, a user 14 having a plurality of target devices 16 communicatively coupled to each other with at least one of the target devices 16 communicatively coupled to a mobile communication network 18 via an access point 20. The mobile communications network, for example, may include wireless modems, a wireless LAN, a wireless Personal Area Network (PAN), cellular telephone networks, digital communication systems, and so forth.

The service provider 12 includes a content server 22 for storing the content for distribution, a target selector 24 for determining a target 16 most suited for reception of the content, and a protocol selector 26 for determining an optimal communication protocol for delivery of the content. The target devices interoperate via a number of radio technologies such as the IEEE 802.11 wireless specification, the Shared wireless access protocol (SWAP) from HomeRF and the BLUETOOTH specification. In a preferred embodiment, the radio technology used for communication between the devices is preferably the BLUETOOTH specification.

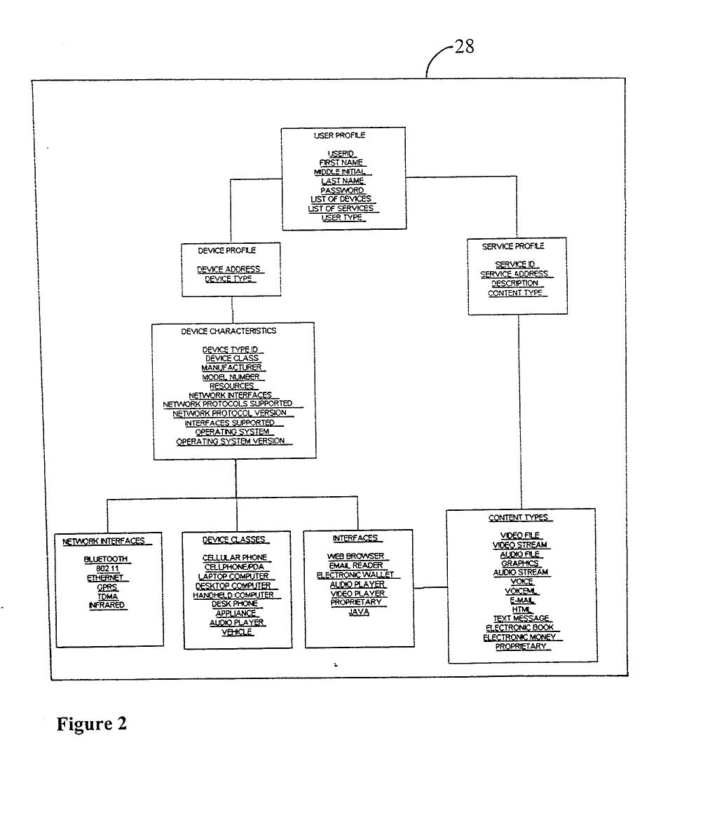

Now referring to FIGS. 1 and 2, each user 14 is associated with a global profile 28 which includes a user profile comprising the user's 14 attributes such as user name and preferences and device 16 usage patterns. The user profile is stored on a personalization server 30 for retrieval and referencing by the content server 22. In a preferred embodiment, each user 14 has at least one target device 16 for interacting with the system 10 for content request and retrieval. Such a target device 16 is preferably configured to conform with the BLUETOOTH technology specifications and may include a personal computer (PC), a cellular phone, a telephone, a personal digital assistant (PDA), an appliance, an audio player or a vehicle.

Each of these devices 16 has specific device characteristics such as a device address, a device class, device status information, manufacturer, model number, resources, network interfaces, supported network protocols, supported network protocol version, supported user interfaces, operating system and operating system version. The device characteristics are compiled and archived in a device characteristics server 32 to form part of the global profile 28. Both the personalization server 30 and the characteristics server 32 are involved in the process of selecting an appropriate target 16 for delivery of the content, and are included in the protocol selector 26. Thus, the global profile 28 represents a personal, customized environment that is localized around any one of the devices 16 or one particular device 16.

The content server 22 stores the content which may include, but is not limited to text messages, video files, audio files, maps, video-streaming, photos, graphics, voice, voicemail, email, HyperText Markup Language (HTML) and electronic commerce transactions. The target selector 24 includes a mobility server 34 for monitoring the network parameters such as traffic data and Quality of Service (QoS), and delivering the content accordingly.

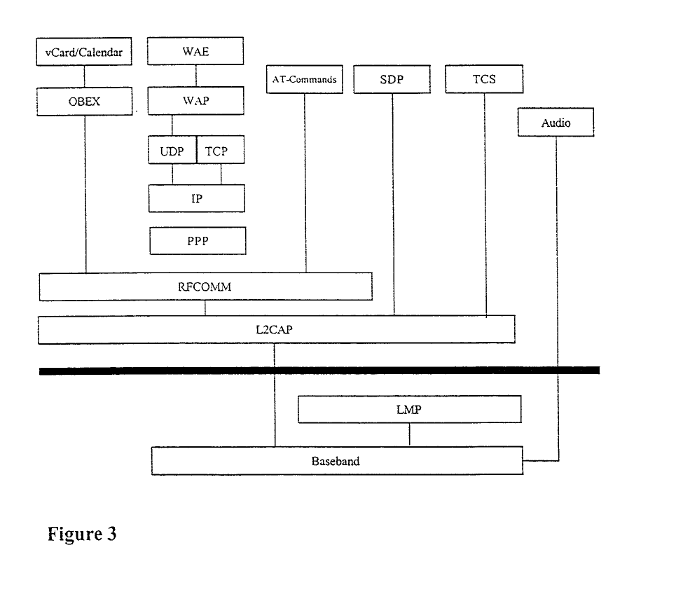

In the preferred embodiment, the device's 16 interoperability is achieved by the BLUETOOTH protocol stack 36 which allows BLUETOOTH-enabled devices 16 to connect and exchange data, as shown in FIG. 3. The complete protocol stack 36 comprises of both BLUETOOTH-specific protocols like LPM and L2CAP, and non-BLUETOOTH-specific protocols like OBEX (Object Exchange Protocol) and UDP (User Datagram Protocol).

The Logical Link Control and Adaptation Protocol, L2CAP, supports multiplexing of protocols, such as Service Discovery Protocol (SDP), RFCOMM and Telephony Control (TCS), and performs segmentation and reassembly of packets. The SDP defines how a BLUETOOTH device application behaves to discover available BLUETOOTH servers' services and their characteristics. RFCOMM is a serial port emulation protocol which emulates RS232 control and data signal over the BLUETOOTH baseband. RFCOMM thus provides transport capabilities for upper level services such as PPP that uses serial line for transport. TCS binary is a bit oriented protocol that defines the call control signaling for the establishment and release of speech and data calls between BLUETOOTH-enabled devices 16.

For example, in order to exchange a business card between two BLUETOOTH-enabled devices via a vCard application, the following protocols from the protocol stack 36 are used: vCard-OBEX-RFCOMM-L2CAP-Baseband. The OBEX protocol enables the exchange of data objects. As evident from FIG. 3, not all applications make use of all the protocols shown in the protocol stack 36, instead, applications run over one or more vertical slices from this protocol stack 36. Typically, additional vertical slices are for services supportive of the main application, like TCS Binary (Telephony Control Specification), or SDP (Service Discovery Protocol).

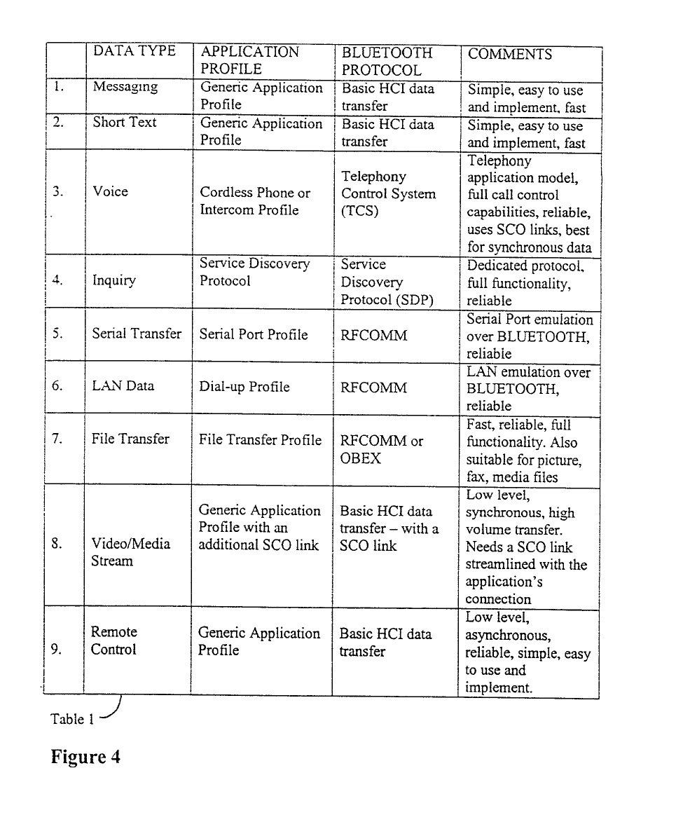

Again looking at FIG. 3, it is apparent that there exist different requirements for different application profiles. For example, the requirements for a file transfer profile are different from a telephony application profile, so that the service provider 12 preferably adopts a protocol that is substantially best suited for the delivery of the content to the device 16. Referring to FIG. 4, each data type used by any kind of application is associated with a specific protocol and application profile for the maximization of characteristics like reliability, performance and flexibility, as shown in Table 1. This association is based on the prior analysis of the BLUETOOTH protocol stack 36 and application profiles. For example for a voice profile, there exists two options—specifically using the TCS protocol and the audio protocol, or using the network transfer protocol such that the voice content is transmitted over the TCP/IP protocol, that is voice over IP (VoIP).

As mentioned above, dynamic routing of content to the user 14 is facilitated by the global profile 28, as shown in FIG. 2. The global profile 28 includes a user profile which includes the user's attributes such as, device, first name, last name, password, contact information, user ID, media preferences, list of devices, list of services, device specifications, device addresses, connections available, user type, time-of-day preferences for the user, and location preferences that can be mapped to services required, and so forth. Each user profile is defined and stored in one or more personalization servers 30 and made available to a mobility server's 34 content routing application as required in the content routing process. Based on user preferences defined in a user profile and the user's current location as defined by the access points 20, along with the user device 16 configuration, the content can be routed to the correct user 14, at a specified time, using the most appropriate communication protocol and path to the preferred device 16.

Also included in the global profile 28 are device profiles that include the types of devices 16 available, the device characteristics such as form factor, screen resolution, voice capabilities, data capabilities, screen color depth, amount of volatile memory, supported BLUETOOTH connection adaptors, network interfaces, audio capabilities (stereo, mono, high fidelity), amount of non-volatile memory, processor capacity and type, software applications installed, power consumption information, operating system type and version. Also, the device characteristics may include the types of input and output devices available such as a keyboard, a microphone, a pointing device, a touchscreen, a stylus pen, buttons or controls. The type of network interface may include a BLUETOOTH interface, an IEEE 802.11 interface, an optical interface, an Ethernet interface, a GPRS air-interface, a TDMA air-interface, a GSM air interface or an IrDA interface.

In a situation where the user 14 has a plurality of devices 16, the user 14 may alternatively define a list of preferred devices 16 and create a mapping of the type of content that each of the devices 16 can render. In an ad-hoc network configuration, where one device 16 serves as a master and the other devices serve as slaves, the global profile 28 may be located in one or more devices 16. The mobility server 34 obtains device characteristics from the device characteristics server 32 and optionally caches this information locally at the mobility server 34. Also, groups of devices 16 can be created that describe a class of devices 16 such as all PalmOS based devices supporting XHTML content. Other device classes may include handheld computers, laptop computers, desktop computers, cellular phones, telephones, appliances, multi-media devices, audio players, vending devices, automatic teller machines, point of sale terminals, access points, kiosks and vehicles.

Now referring to FIGS. 1 and 2, the user profile 28 is stored in the mobility server 34 and the user 14 is assigned specific access privileges, such as, permitted media types or bandwidth restrictions. An extension to this is possible where existing user directory technologies and servers such as LDAP servers are used to retrieve basic user information or to store the entire user profile information. The device characteristics for all of the devices 16 supported are obtained from a device characteristics server 32. These device characteristics are entered into the device characteristics server 32 from other device characteristics servers 32, either manually by the user 14 when subscribing to the services, or dynamically by the service provider 12 by querying the device 16 as it participates in the system 10.

A list of available services is defined, including the type of content they support such as voice, data, video, streaming audio and the location or address of the content. For example, one service may support multiple types of content as illustrated by a video game which has audio, video, text, while a broadcast service which supports video and audio and interactive broadcast service would support audio, video, and text messaging example with a Web-based service, the root URL of the content is provisioned into the system. Each service is mapped to the list of appropriate devices 16 that support the services. This limits the user 14 to selecting the services for which there is a suitable device 16 for reception of the content. The services may also be grouped into collections in order to facilitate administration and access control.

In addition, in order to provide easier administration and service control, a list of supported locations is defined and configured. Such locations can be specific to geographical areas of coverage, and may include coordinates of access points 20, such as the longitude and the latitude, or can be a logical grouping of locations such as regions, cities, or countries. A mapping is then created between the locations and the access points 20 to provide a lookup table of the available access points 20. The list of services is then mapped to the specific access points 20 that provide those services, so that the list of access points 20 installed in the system 10 is configured in the mobility server 34. The system 10 may also support dynamic and automatic detection and registration of new access points 20 as they are added to the network 18. Preferably, the access points 20 may provide their location to the mobility server 34 for automatic registration. Also, a mapping between services, time-of-day availability, and the locations and access points 20 at which those services are available is also stored in the mobility server 34.

The various mappings between protocols, content, and devices 16 is also defined in the mobility server 34 to enable the dynamic content and protocol selection for determination of an appropriate route to send the content. In order to improve the QoS and reliability some, or all, of the mobility servers' 34 functionality may be duplicated or duplicated throughout the network 18.

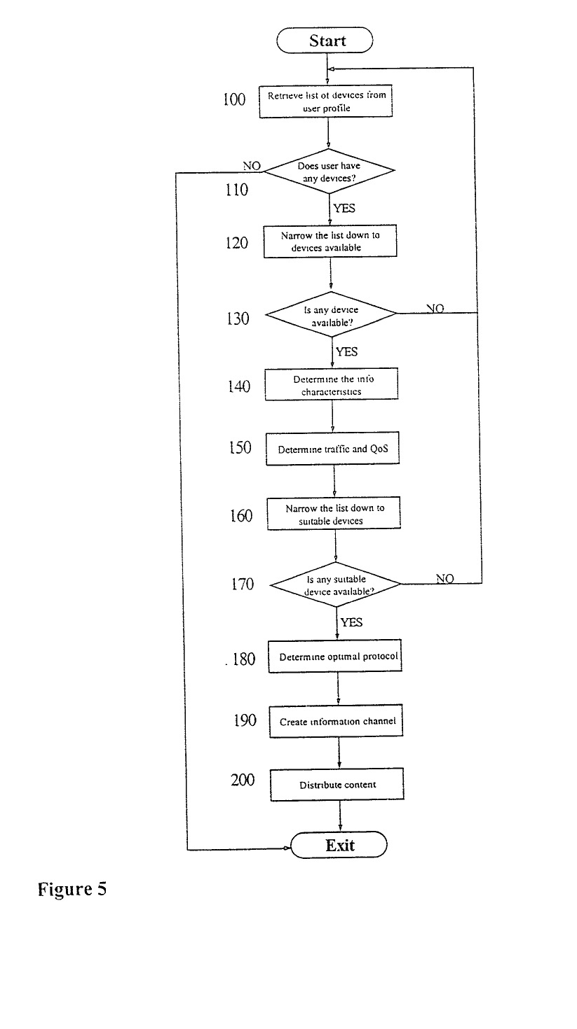

The flowchart in FIG. 5 describes the steps through which the system 10 determines the routing of requested content and the type of connection to be used for the content distribution to the device 16. The mobility server 34 has knowledge of the location of the device 16, including addressing information for establishing a communication path with the device for delivery of content. Accordingly, the device 16 is preferably configured to register its location with the mobility server 34 every time it moves into the connectivity area of a new access point 20. Therefore, in response to a request for content the service provider 12 retrieves 100 the list of devices 16 associated to the user 14 from the user profile, and then a check is performed 110 to determine whether the user 14 has any devices 16. Alternatively, the service provider 12 may be configured to send or “push” content to a user 14 in accordance with the user's 14 preferences; such content may include time-sensitive content such as weather information or stock alerts. In the event that the user 14 does not have any devices 16 then the process stops. In the next step 120, a second list of available devices 16 for receiving the content is created and the mobility server 34 determines 130 the status of the available devices 16. The devices 16 may be in parked status or in active status and ready to receive content.

In the following step 140 the characteristics of the content to be distributed are retrieved and are used in determining which of the devices 16 from the second list of available devices 16 have the ability to render the content. In step 150 the traffic and Quality of Service (QoS) characteristics of the communication network 18 are determined and are used in the selection of the optimal protocol and type of connection.

In step 160, the second list of available devices 16 is narrowed to a third list of available devices 16 that can process the content with the specific characteristics and in step 140, if there is no such device 16 the process 170 terminates unsuccessfully. In the next step 180, the optimal protocol is chosen based on the device 16 characteristics and considering the traffic and QoS characteristics of the system 10, as determined in step 150. Following the detection of the best-suited device 16 and the optimal protocol for the content, the appropriate connection is created 190 and opened and finally, the content is distributed 200 to the best-suited device 16.

Preferably, in step 180, further steps are possible to cycle through the remaining protocols supporting the specific type of content in order to use sub-optimal alternatives in cases where a connection with the optimal protocol could not be established. Also, a further the step of selecting another protocol is possible when the best suited protocol is unavailable, as it maybe in use at that time. Conversely, step 160 or 170 may include further steps of determining other devices 16 that may be available and are capable of supporting the content to be delivered, despite not being the best-suited or preferred device for that particular content type. Also, a further the step of selecting another device is possible when the best suited device is unavailable, as it maybe in use at that time.

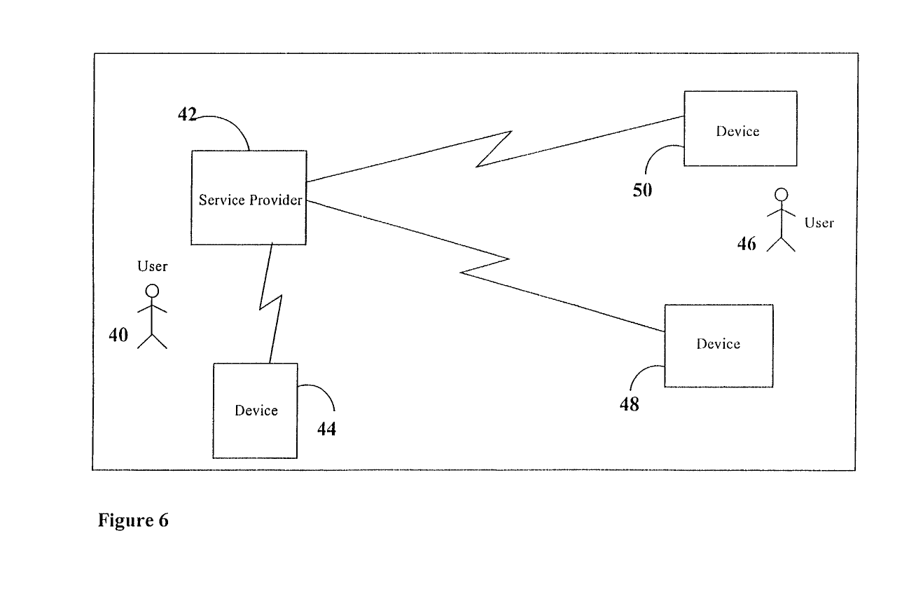

In another embodiment, any BLUETOOTH-enabled device 42 that comes within range of another BLUETOOTH-enabled device 44 can set up an ad-hoc network or a piconet, where there is no actual access point 20 connecting to the Intemet or Intranet, as shown FIG. 6. One user 40 dynamically provides services from a user device 42 or user devices 42 and 44 to another user 46 with user devices 48 and 50. AS the devices 48 and 50 are within range of the user 42 providing the services, then the user 46 can request to subscribe to any one of the services available from device 42. In some cases this may require user authentication and if accepted by the user 42, an entry is created in a user profile database located on the user device 42, so that user 40 is a service provider for user 46. However, prior to providing the services, the user 40 preferably configures a list of available services in a service profile. Examples of services may include Web-based content from the device's 40 cache memory, small applications transferred to the other user's 46 devices 48 and 50 which then communicate back to the user's 40 device 42. It is also contemplated that several piconets can exist in the same area to form a scatternet, one or more user devices acting as service providers and including many of the functionalities of a service provider.

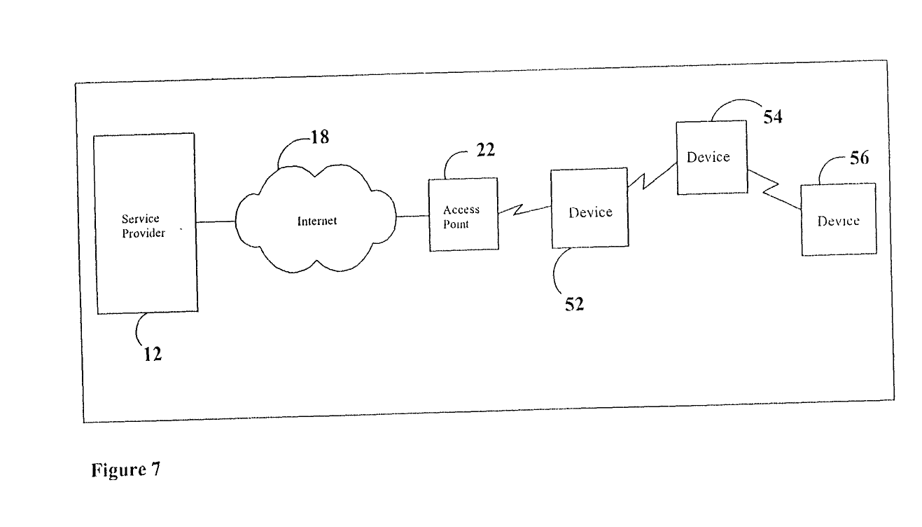

In yet another embodiment, similar to the preferred embodiment of FIG. 1, except with two or more devices 52, 54 and 56 communicatively coupled to each other in an ad hoc network, with one of the devices 52 coupled to the communication network 18 via an access point 20, as shown in FIG. 7. The devices 54 and 56 may be out of range of the access point 20 and do not have a direct communication path to the network 18 via the access point 22, as dictated by the operating specifications of the communication standard, such as BLUETOOTH. In the event that the device 56 is selected by the target selector 24 from a list of available devices 52, 54 and 56, then the device 52 acts an intermediary for routing the content to device 56, preferably via BLUETOOTH technology. For example, voice content may be sent via the access point 20 to the device 52, such as a personal computer to the device 52, which can be a telephone, as this device 56 would be best suited for such content. Therefore, the access point 20 serves as a wireless to wire-line gateway between the communication network and any wireless device within the coverage area.

The above-described embodiments of the invention are intended to be examples of the present invention and alterations and modifications may be effected thereto, by those of skill in the art, without departing from the scope of the invention which is defined solely by the claims appended hereto.

The embodiments of the invention in which are exclusive property or privilege is claimed are defined as follows:

1. A method of delivering content from a service provider to a plurality of users, with each user having at least one mobile device in a communication network, said method having the steps of:
associating said content with a plurality of data types;
associating each user with a global profile having the characteristics of said at least one device and user attributes to said service provider;
selecting at least one device being best suited to receive said content; and
selecting a communication protocol for transport of said data type in accordance with said global profile and said data type.

2. The method of claim 1, wherein said characteristics of a device include a device address, a device class, device status information, manufacturer information, a model number, available resources, network interfaces, supported network protocols, a supported network protocol version, supported interfaces, an operating system, and operating system version.

3. The method of claim 1, wherein said user attributes include first name, last name, password, contact information, user ID, user type, media preferences, list of devices, list of services, device specifications, device addresses, connections available, geographical location and preferred tine for reception of content.

4. The method of claim 2, wherein said device class includes a wireless device, a handheld computer, laptop computer, a desktop computer, a cellular phone, a telephone, an appliance, a multi-media device, an audio player, a vending device, an automatic teller machine, a point of sale terminal, an access point, a kiosk and a vehicle.

5. The method of claim 2, wherein said device address includes a MAC address, an e-mail address, a phone number, a pager number and an IP address.

6. The method of claim 3, wherein said device address includes a MAC address, an e-mail address, a phone number, a pager number and an IP address.

7. The method of claim 1, wherein the step of associating each user with a global profile includes a further step of said user specifying said characteristics of said at least one device and user attributes to said service provider.

8. The method of claim 1, wherein the step of associating each user with a global profile includes further steps of said service provider querying said at least one device to determine said characteristics of said at least one device and subsequently registering said device characteristics automatically.

9. A method of distributing content to a plurality of users in communication network, the method hang the steps of:
associating each user with at least one device for handling said content;
associating each user having a user profile and associating each device having a device profile;
associating said content with a plurality of data types;
determining the data type of the content requested;
checking the availability of a user device for reception of said content;
determining suitability of said user device for reception of said content; and
dynamically determining an optimal communication protocol for transmission of said content to said user device in accordance with said user profile, said device profile and said data type.

10. The method of claim 1, wherein said data types include text messages, voice, audio files, audio streams, video files, video streams, multimedia streams, serial transfers, data transfers, email, proprietary data, control and signaling messages, secure transaction data, enterprise data, and any combination thereof.

11. The method of claim 9, wherein said data types include text messages, voice, audio files, audio streams, video files, video streams, multimedia streams, serial transfers, data transfers, email, proprietay data, control and signaling messages, secure transaction data, enterprise data, and any combination thereof.

12. The method of claim 9, wherein said step of associating said content with a plurality of data types further involves the step of associating said data types with an optimal application profile and a BLUETOOTH protocol.

13. The method of claim 10, wherein said step of associating said content with a plurality of data types further involves the step of associating said data types with an optimal application profile and a BLUETOOTH protocol.

14. The method of claim 9, wherein said step of dynamically determining said communication protocol further includes the steps of:
creating a hierarchical list of protocols for each of said data type, said hierarchical protocol list having at least one of said communication protocols being most suited for transport of said data type and at least of said communication protocols being least suited for transport of said data type; and
selecting said optimal protocol in order of preference from said hierarchical protocol list.

15. The method of claim 9, wherein said step of determining said suitability of a device further includes the steps of:
creating a hierarchical list of devices for each of said data type, said hierarchical device list having at least one of said device being most suited for reception of said data type and at least one of said device least suited for reception of said data type; and
selecting said optimal device in order of preference from said hierarchical device list.

16. The method of claim 9, wherein said step of determining a communication protocol further includes a step of mapping a protocol request to said device characteristics in accordance with said device profile.

17. The method of claim 14, wherein said step of determining a communication protocol further includes a step of mapping a protocol request to said device characteristics in accordance with said device profile.

18. The method of claim 9, wherein said step of selecting an optimal protocol further includes the step of selecting another protocol from said hierarchical protocol list when said best suited protocol is unavailable.

19. The method of claim 14, wherein said step of selecting an optimal protocol further includes the step of selecting another protocol from said hierarchical protocol list when said best suited protocol is unavailable.

20. The method of claim 9, wherein said step selecting an optimal 1 device further includes the step of selecting another device from said hierarchical device list when said best suited device is unavailable.

21. The method of claim 15, wherein said step selecting an optimal 1 device further includes the step of selecting another device from said hierarchical device list when said best suited device is unavailable.

22. A content distribution system for distributing content to a plurality of users from a service provider, each user having a plurality of targets communicatively coupled to each other with at least one of said targets communicatively coupled to a communication network, each user associated with a global profile having user preferences for said content delivery and target characteristics and said content having a plurality of data types, said system further having:
a target selector for determining a target most suited for reception of said content in accordance with said global profile and said data type;
a protocol selector for dynamically determining an optimal communication protocol for delivery of said content in accordance with said global profile and said data type; and
a content server communicatively coupled to said target selector and protocol selector for distribution of said content.

23. The system of claim 22, wherein said service provider initiates content distribution to said users in accordance with said user's preferences.

24. The system of claim 23, wherein said content includes time-sensitive information, alerts, meteorological information, stock quotes, money market alerts, instant messaging and email alerts, voice, audio, video and multimedia streams, control and signaling messages.

25. The system of claim 22, wherein content distribution to said users is initiated by said service provider in accordance with said user preferences.

26. The system of claim 22, wherein the protocol selector includes a personalization server and a device characteristic server for storing said global profiles.

27. The system of claim 22, wherein said target selector includes a mobility server monitoring said network parameters such as traffic data and Quality of Service (QoS), and delivering said content accordingly.

28. The system of claim 22, wherein said content server includes content of said plurality of data types including text messages, voice, audio files, audio streams, video files, video streams, multimedia streams, serial transfers, data transfers, email, proprietary data, control and signaling messages, secure transaction data, enterprise data, and any combination thereof.

29. The system of claim 22, wherein said global profile having a plurality of user profiles, target profiles, service profiles and target characteristics.

30. The system of claim 22, wherein said target is chosen from a set of mobile devices including a mobile phone, a personal digital assistant, or a personal computer.

31. The method of claim 1, wherein said devices communicate with each other via a communication protocol allowing interoperability between similar or dissimilar devices.

32. The method of claim 9, wherein said devices communicate with each other via a communication protocol allowing interoperability between similar or dissimilar devices.

33. The method of claim 1, wherein said communication protocol is based on the BLUETOOTH standard, the IEEE 802.11 standard the IrDA standard or the HomeRF shared wireless access protocol (SWAP).

34. The method of claim 9, wherein said communication protocol is based on the BLUETOOTH standard, the IEEE 802.11 standard, the IrDA standard or the HomeRF shared wireless access protocol (SWAP).

35. The system of claim 22, wherein said communication protocol is based on the BLUETOOTH standard, the IEEE 802.11 standard, the IrDA standard or the HomeRF shared wireless access protocol (SWAP).

36. The method claim 2, wherein said network interfaces include a BLUETOOTH interface, an IEEE 802.11 interface, an optical interface, an Ethernet interface, a GPRS air-interface, a TDMA air-interface, a GSM air interface and an IrDA interface.
